(19) United States
(12) Patent Application Publication
(10) Pub. No.: US 2007/0143015 A1
(43) Pub. Date: Jun. 21, 2007

(54) Method for operating an active gps receiver using a bts position remote input

(76) Inventor: Do Kyoung Kim, Seoul (KR)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 10/550,426

(22) PCT Filed: Mar. 24, 2004
(86) PCT No.: PCT/KR04/00646

§ 371 Date: Jan. 26, 2007

(30) Foreign Application Priority Data
Mar. 25, 2003 (KR) 10-2003-0018544

(51) Int. Cl. G01C 21/00

(52) U.S. Cl. 701/213

(57) ABSTRACT

The present invention relates to a method of operating an active GPS receiver using a base station position remote input. So that the GPS receiver can operate normally and at a high speed even in a base station's initial power authorization which may be under a poor receiving circumstances by inputting a base station's position information to a GPS receiver form a distance. This invention comprises: checking an inside activation by itself after power is initiated and authorized; requesting position information to a BSM when within a normal state; setting the action information by the received position information when the position information is received after the above position information is requested; and entering a conventional operating state when at least more than one satellite signal is received. In addition, after requesting the position information, when position information is not received within a set time, outputting of the position information is automatically initiated. The position information is calculated when satellite signals of more than four of the above items are received by checking whether more than four satellite signals are received or not. The above position information calculation value is accumulated during a prescribed time. When the accumulated time exceeds the above prescribed time, an action position is set to a calculated position information.

### TECHNICAL FIELD

The present invention generally relates to a method of operating a GPS receiver based on a remote input of a base station's position, and more particularly to a method of operating a GPS receiver through remotely inputting positional information of the base station thereto when the base station is initially powered.

### BACKGROUND ART

Typically, a conventional CDMA (Code Division Multiple Access) mobile communication system uses a GPS receiver for transmitting an accurate frequency to each base station and for further synchronizing the same. The GPS receiver usually requires at least four receiving satellites to operate after being initially powered.

This is because the GPS receiver needs to calculate the distance from its operating position to the satellite. Such distance needs to be calculated in order to acquire accurate time information based upon signals received from the satellite.

Therefore, four satellite signals are typically required during the initial operation to obtain four unknown quantities therefrom. The four unknown quantities are corresponding positions (i.e., latitude, longitude and altitude) and visual information.

However, a conventional base station often has poor satellite signal reception due to the positioning of its antenna and the like. Hence, it may tale quite awhile for the base station to receive four satellite signals. Accordingly, an extensive amount of time may be required before the base station achieves its normal mode of operation.

### BRIEF DESCRIPTION OF DRAWINGS

FIG. 1 is a schematic view illustrating a mobile communication system constructed in accordance with a preferred embodiment of the present invention; and

FIG. 2 is a flow chart illustrating a method of operating a GPS receiver based on a remote input of a base station's position in accordance with a preferred embodiment of the present invention.

### DISCLOSURE OF TH INVENTION

The primary objective of the present invention is to provide a method of operating a GPS receiver based on a remote input of a base station's position. This is so that the GPS receiver can operate promptly and efficiently in its normal mode of operation through remotely inputting the base station's positional information to the GPS receiver, especially when the base station with poor satellite reception becomes initially powered.

To achieve the above objective, the method of operating a GPS receiver based on a remote input of a position of a base station in a mobile communication system comprises the following steps:

self-checking an internal operation when power is initially applied, and requesting positional information to a Base Station Management station (BSM) when a status of the GPS is in a normal state; and

setting an operating position according to a received information when the information is received within a set time after requesting the positional information, and entering a normal operating state when one or more satellite signals are received.

The set time is preferably about 10 seconds.

The method described above further comprises the steps of:

starting a self-calculation of the positional information when the positional information is not received within other set time after requesting the positional information;

checking whether more than four satellite signals are received;

calculating the positional information when more than four satellite signals are received; and

accumulating the calculated positional information for a predetermined time, and setting the operating position according to the calculated positional information when the accumulated time exceeds the predetermined time.

The other set time is preferably about one minute.

According to the present invention, the required time for a GPS receiver to operate in its normal operational mode can be reduced through remotely inputting the base station's position to the GPS receiver.

### BEST MODES FOR CARRYING OUT THE INVENTION

In view of the provided figures, a preferred embodiment of the present invention, which is in accordance with the subject matter disclosed above, will be described in detail.

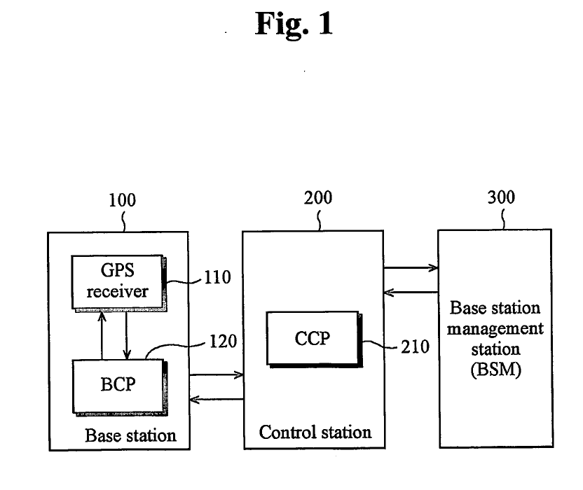

FIG. 1 is a schematic view illustrating a mobile communication system constructed in accordance with the present invention.

Reference numeral 100 indicates a Base Station (BTS) and reference numeral 110 indicates a GPS receiver. GPS receiver 110 outputs the synchronized PP2S with the GPS time as a synchronizing signal of the base station 100. The GPS receiver 100 uses the information received from a satellite and transmits a positional information request signal to a base station management station 300. This is done through HDLC communication at the initial operation after the GPS receiver becomes powered. It then determines its operating position using the received positional information. Accordingly, the GPS receiver can operate promptly and efficiently when in its normal mode of operation.

Reference numeral 120 indicates a Base Station Control Processor (BCP). The BCP 120 transmits a positional information request signal transmitted from the GPS receiver 110 to a control station 200. It also transmits the positional information transmitted via the control station 200 to the GPS receiver 110.

Reference numeral 200 indicates the control station and reference numeral 210 indicates a Call Control Processor (CCP). The CCP 210 transmits a positional information request signal inputted from the base station control processor 120 to the base station management station 300. It also transmits the positional information transmitted from the base station management station 300 to the base station control processor 120.

Reference numeral 300 indicates a Base Station Management station (BSM) that manages positional information of each base station. When an operator accurately knows the information of a corresponding base station, the BSM can manage the information of the base station by inputting the information manually. Otherwise, the BSM can receive the information of the corresponding base station from the GPS receiver 110 entering its normal operational status and manage the same. Furthermore, when the GPS receiver 110 of the base station 100 is restarted and the BSM receives the positional information request signal from the GPS receiver 110, the BSM transmits positional information of the managed base station to the GPS receiver 110. This is done through the CCP 210 and the base station control processor 120.

The general operation of a mobile communication system constructed in accordance with the present invention will be described below.

The GPS receiver 110 requests its operating positional information to the base station management station 300 through the base station control processor 120 and the CCP 210 at the initial operation. When the positional information is received from the base station management station 300, the GPS receiver enters into its normal mode of operation with the corresponding position.

However, when the positional information is not received from the base station management station 300, the GPS receiver then determines the operating position by receiving more than four satellite signals. Thereafter, it enters into its normal operational mode.

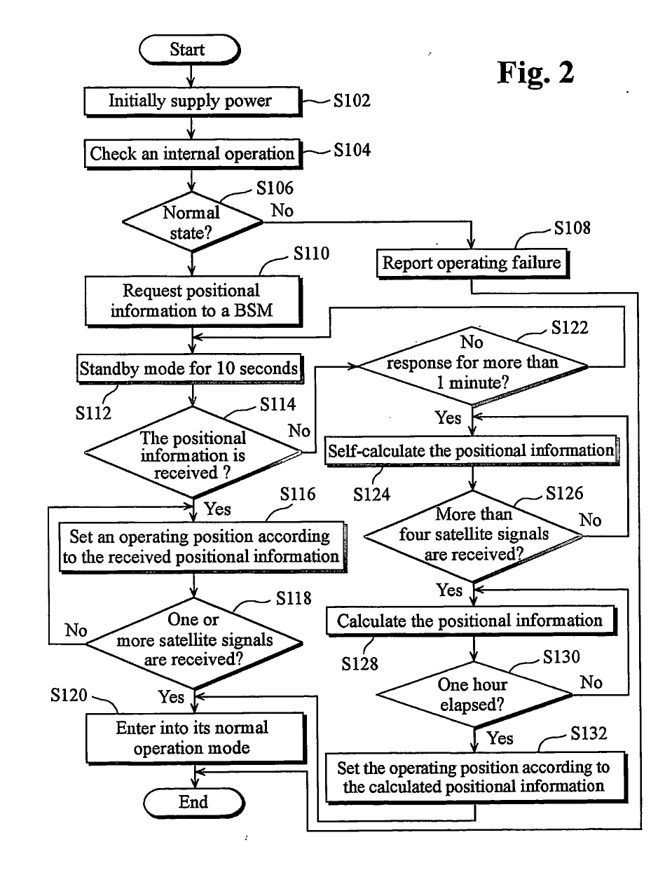

FIG. 2 is a flow chart showing a method of operating a GPS receiver based on a remote input of a base station's position in accordance with the present invention.

As illustrated in FIG. 2, the method comprises the steps of: self-checking an internal operation when the GPS receiver is initially powered, and requesting positional information to a Base Station Management station (BSM) when its status is in a normal state (S102-S110);

setting an operating position according to received information when the information is received within a set time after requesting the positional information, and entering a normal operating state when one or more satellite signals are received (S112-S120);

starting self-calculation of the positional information when the positional information is not received within other set time after requesting the positional information (S122-S124); checking whether more than four satellite signals are received (S126);

calculating the positional information when more than four satellite signals are received (S128); and

accumulating the calculated positional information for a predetermined time, and setting the operating position according to the calculated positional information when the accumulated time exceeds the predetermined time (S130-S132).

A method of operating a GPS receiver based on a remote input of a base station's position in accordance with the present invention will be described.

First, when the GPS receiver initially becomes powered at S102, the GPS receiver self-checks an internal operation at S104. For example, a memory test is performed.

At S106, the GPS receiver is then checked as to whether its status is in a normal state. In the event that a failure occurs in an inner system, an operating failure is reported at S108.

If the status is in a normal state or mode, then the GPS receiver will request positional information to the Base Station Management station (BSM) at S110.

At S112, the GPS receiver is in a standby mode for a set time (i.e., preferably about 10 seconds). It then checks whether the positional information is received at S114 after the set time.

When the positional information is received, the GPS receiver sets an operating position according to the received information at S116. Whether one or more satellite signals are received is checked at S118.

If one or more satellite signals are received, then the GPS receiver will enter into its normal operational mode at S120.

According to the present method described herein, even though the satellite signal is poorly received because the GPS is initially powered, the GPS receiver can promptly and efficiently enter into its normal operational state.

It is checked at S114 whether the positional information is received. If the positional information is not received, then the GPS receiver will check at S122 whether any response exists (i.e., whether any positional information is received) for more than other set time (i.e., approximately about one minute).

If the other set time does not elapse, then the process returns to S112. In the event that there is no response after the other set time elapses, the GPS receiver then self-calculates the positional information at S124.

It is checked at S126 whether more than four satellite signals are received. When more than four signals are not received, the process returns to S124 and positional information calculating operation is performed continuously. However, when more than four signals are received, the GPS receiver calculates the operating positional information by using the received satellite signals at S128.

The positional information calculation is performed for approximately an hour. At S130, the GPS receiver checks whether the calculation is performed for about one hour. If the calculation is performed for more than one hour, then the GPS receiver extracts the final positional information by averaging positional information values calculated for about one hour. At S132, the operating position is set according to the extracted positional information. The GPS receiver enters into its normal mode of operation at S120.

If the positional information request signals were received from the BSM after setting the operating position, then the GPS receiver transmits the calculated positional information to the BSM. The BSM manages this information. When the GPS receiver 110 is re-initialized, the BSM managing the calculated positional information then transmits the managed information in response to the position request signal.

When the BSM manager knows the accurate position of the base station, he or she can operate the BST by inputting the known information to a corresponding field of BSM 300. When the BSM manager does not know the accurate position of the base station in which the GPS receiver has operated for at least one time, the required time from re-initialization of GPS receiver 110 to the normal status can be reduced. This is because the positional information is managed automatically.

1. A method of operating a GPS receiver based on a remote input of a position of a base station in a mobile communication system, the method comprising the steps of:
self-checking an internal operation when power is initially applied;
requesting positional information to a Base Station Management station (BSM) when the GPS receiver is in a normal state;
setting an operating position according to the positional information when the information is received within a set time after requesting the positional information; and
entering a normal operating state when at least one satellite signal is received.

2. The method of claim 1 wherein the set time is approximately 10 seconds.

3. The method of claim 1 further comprising the steps of:
starting a self-calculation of the positional information when the positional information is not received within other set time after requesting the positional information;
checking whether at least four satellite signals are received;
calculating the positional information when the at least four satellite signals are received;
accumulating the calculated positional information for a predetermined time; and
setting the operating position according to the calculated positional information when the accumulating time exceeds the predetermined time.

4. The method of claim 3 wherein the other set time is approximately one minute.

5. The method of claim 1 or 3 further comprising the steps of:
transmitting the calculated positional information to the Base Station Management station (BSM) when the positional information request signal is received from the BSM after setting the operating position; and
entering the normal operating state promptly by receiving the calculated positional information from the BSM when the GPS receiver is re-initialized.
